(19) United States
(12) Patent Application Publication
(10) Pub. No.: US 2005/0205408 A1
(43) Pub. Date: Sep. 22, 2005

(54) Use of windpower to generate both electricity and potable water

(76) Inventors: Douglas G. Marsh, Bethlehem, PA (US); Apparajan Ganesan, Venus, TX (US)

Correspondence Address: Douglas G. Marsh, 1031 Graham St, Bethlehem, PA, 18015, US

(21) Appl. No.: 10/805,506

(22) Filed: Mar. 22, 2004

(51) Int. Cl. B01D 3/10

(52) U.S. Cl. 202/234; 159/903; 203/10; 203/DIG. 1

(57) ABSTRACT

In accordance with the present invention, a conventional wind turbine used to generate electricity is modified to have a transparent roof, the roof being constructed in a way similar to seawater distillation plants. A small portion of the electricity generated by wind turbines is used to pump unpurified water to the roof of the generation system where it is distilled into pure drinking water. This water can then be gravity fed or pumped, again using the electricity from the turbine, elsewhere for storage and eventual use. Periodically, the purification process can be shut down and either purified or unpurified water can be used to flush the pollutants back to the water source and to clean the outside of the roof, and energy needed for these operations is also obtained from the electricity generated by the turbines. The system provides a means of adding to the purity of the water by killing bacteria with ultra-violate radiation and a means of storing excess wind generated electricity in the form of potable water.

### CROSS-REFERENCE TO RELATED APPLICATIONS

Not applicable.

### BACKGROUND

1. Field of Invention

This invention relates to means for using wind turbines that generate electricity to also generate potable water.

2. Description of Prior Art

The generation of electricity by wind turbine farms is becoming increasing wide spread as a clean alternative to fossil fuels or nuclear generation (see, for example, “The New York Times Circuits: How Electronic Things Work,” © 2001 by The New York Times, ISBN 0-312-28439-X, pages 116-117). Until recently, most wind farms have been placed along ridge tops, such as in California However, recently places such as off the coast of Rhode Island and in the North Sea of Great Britain have been identified as places for sea based wind farms. The tops of these wind turbines where the actual electric generators are housed are typically several hundred square feet in area and have an unrestricted view of the sky.

Throughout the world, especially in arid regions near the ocean, distillation plants are used to convert seawater into potable water. Large areas of real estate are covered with translucent or transparent material. Water is run below the covering, and the heat from the sun distills the water, taking pure water to the underside of the cover and leaving the impurities behind. When the water vapor contacts the underside of the cover, it condenses back into water, and the underside is constructed in a way to carry off the potable water for storage and eventual use.

U.S. Pat. Nos. 4,471,612 and 6,308,521 use wind as an aid in the evaporation process and require very specialized hardware structures. A third U.S. Pat. No. 4,883,823, integrates separate wind farms and distillation and electrolysis of water to produce methanol.

### SUMMARY

In accordance with the present invention, the two processes of using a wind turbine to generate electricity and a distillation system to purify water are combined into one structure, any pumping energy needed for the distillation process and its maintenance can be directly obtained as a small portion of the wind turbine generated electric energy, and any residual electrical energy not used elsewhere can be used to aid the distillation process.

### OBJECTS AND ADVANTAGES

Accordingly, several objects and advantages of this invention are:
(a) A water distillation system is added to the wind turbine system without any significant additional use of real estate.
(b) The cost of the distillation system is partly offset by simply using a different material for the roof of the turbine system.
(c) Energy to pump the potable water elsewhere for storage is directly obtained from the wind turbine.
(d) Energy to maintain the cleanliness of the parts of the system used to transport unpurified water is directly obtained from the wind turbine, and the water used for this operation is also readily available from either the unpurified or potable water.
(e) Energy to maintain the translucent or transparent properties of the roof needed for good distillation is directly obtained from the wind turbine, and the water used for this operation is also readily available from either the unpurified or potable water.
(f) If the turbine is generating more electricity than is needed elsewhere, the residual energy can be used to aid the distillation process, in effect storing excess electrical energy as potable water.
(g) Bacteria present in the unpurified water is killed by the ultra-violate radiation, significantly reducing cross pollution from the impure water to the purified water.
(h) Residual energy can also be used for an electrolysis process to produce chlorine to add to the pure water to protect against future bacteria growth.
(i) The sides of the wind turbine can be used for solar cells which can aid in the distillation process, especially when there is no wind.

### DRAWING FIGURES

FIG. 1. A Conventional wind turbine for electrical energy generation.

FIG. 2. Modifications to a conventional wind turbine system to add water distillation.

FIG. 3. Wind turbine erected at sea.

FIG. 4. Electrolysis added to system.

FIG. 5. Solar cells added to system.

### DESCRIPTION—PREFERRED EMBODIMENT

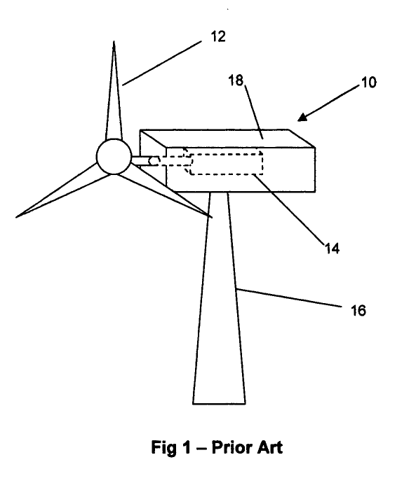

FIG. 1 shows a conventional wind turbine 10 that is commonly found in large wind farms for generation of electricity. Its primary elements are the rotor system 12, a turbine 14, and a support tower 16 that might be a hundred or more feet high. The surface of the roof 18 may be somewhat curved or reasonably flat. Typically, the pitch of the rotors 12 and the yaw of the turbine 10 are adjusted for optimum operation as wind velocity and direction change.

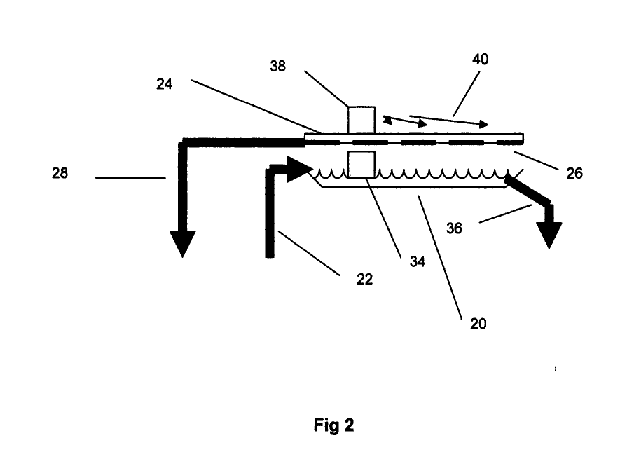

The wind turbine modifications to also produce potable water are shown in a cut away view of the roof in FIG. 2. The evaporator 20 of a conventional water distillation system, which receives the impure water 22, and the evaporator is placed below a translucent or transparent roof 24. The water condenser portion of the distillation system 26 is incorporated in or placed below the roof. Potable water 28 flows from the condenser.

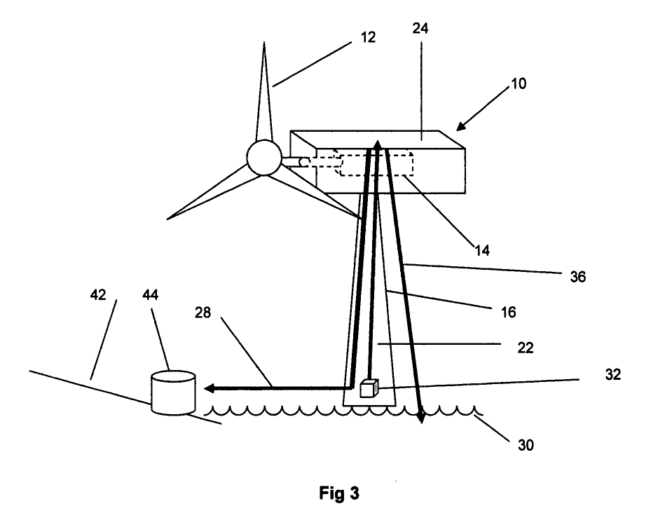

In the preferred embodiment in FIG. 3, the turbine is erected at sea, so the source of water 30 is seawater and is therefore unsuitable for drinking.

In FIG. 2, pump means 32 are added as needed to bring the unpurified water up to the evaporator 20. Pumps 34 can also be placed so that water can be run at a higher flow rate through the evaporator 20 to periodically flush it of impurities through a flush port 36. For best maintenance, potable water should be used for this job, but unpurified water may be sufficient depending on the overall system design and the nature of the impurities. The exterior of the roof may be subject to spray from sea water and dirt and dust accumulation. Pumps 38 can be added to periodically wash 40 the roof. Again, potable water is preferred, but unpurified water may be sufficient depending on the overall system design and the nature of the impurities.

Conventional water distillation plants usually require substantial real estate. In the present invention, the distillation process will be spread over the entire wind farm, so no extra real estate is needed, except possibly for on-land 42 storage 44 of the purified water (FIG. 3). Those skilled in the art will immediately recognize that some storage could be within the tower supporting the turbine or around the base of the tower, further minimizing the need for additional real estate.

Depending on the wind conditions and electrical energy usage by the customers of the wind farm along with the electric power needs of the distillation plant, there may still be additional residual electrical energy. This energy can be applied back into the distillation system to aid that process. One means might be to add turbulence to the surface of the distillatory; another might be to heat the water. Another means is that at night or other times when wind is sufficient to generate more electricity than is being consumed, electricity can be used as a power source to cause the water to evaporate. Other means might be evident to those skilled in the art of water distillation.

Those skilled in the art will immediately recognize that the turbine need not be located at sea. It may be located in or near any source of water that is sufficiently large to keep the system filled, and the proximity of that source of water is limited only by the economics of getting the water to the turbine. The water need not be seawater; a lake, other ground water, or underground supply could work also.

Those skilled in the art will immediately recognize that the pumps used for flushing and roof cleaning may be the same pump means as is used to get the water to the top of the tower, with appropriately placed valves.

Those skilled in the art will recognize that the ultra-violate light shining on the unpurified water will kill much of the bacteria in that water so that the potential for contamination of the post-distillation pure water is substantially reduced. This part of the purification would not, of course, apply if wind generated electricity is driving the evaporation process at night, so some final minimal purification down stream would still be needed.

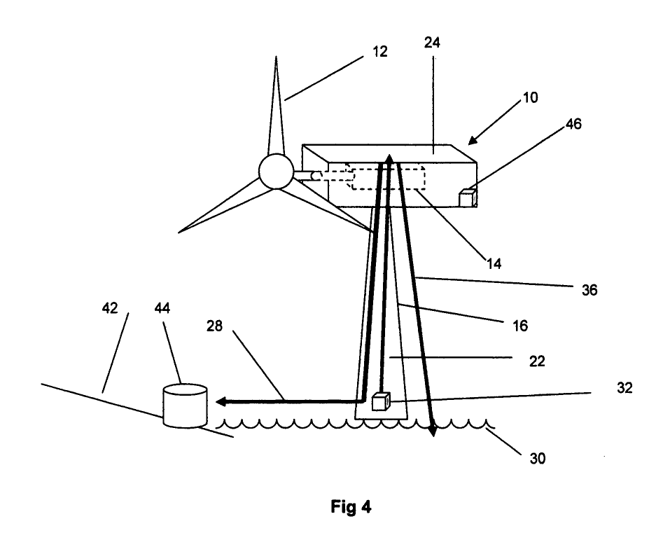

Another simple extension is to use excess electrical power to use electrolysis to break down the salt (sodium chloride) in the sea water to release chlorine, and add the chlorine into the pure water for added protection against future bacteria growth. Only a very small amount of chlorine is needed relative to the amount of water produced, so the added hardware 46 to produce the chlorine can easily to added somewhere within the floor space of the turbine housing (FIG. 4).

To send the potable water to a water storage facility, gravity fed may be sufficient, or pumps can be used, depending on the design of the overall system.

The energy to run any pumps can typically be generated by the turbines.

Those skilled in the art will immediately recognize that since wind cannot be guaranteed 100% of the time, backup electricity generation is needed, as is the case with conventional wind farms.

If the storage facility is located sufficiently high, it would also be possible to place a hydroelectric generator at a lower point and generate electricity as the pure water is used. This would be useful if significant electricity is wind generated but not used during the night and turned into pure water, in essence storing electricity in the form of potable water. Such storage could be used as part of the backup generation needed when wind is not present.

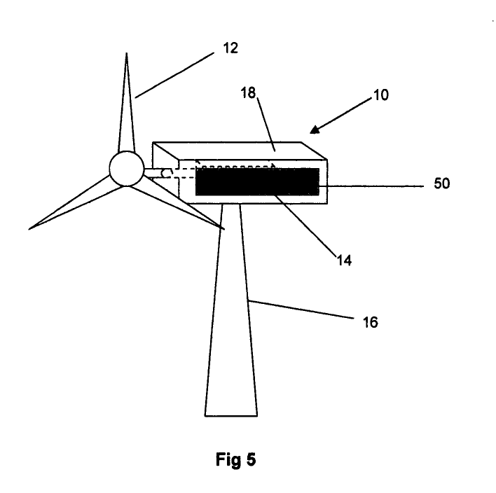

The distillation process will normally be a low cost change to the roof of the turbine structure. Nothing would prevent the sides of the turbine from having solar cells 50 added to them (FIG. 5), and the electrical energy produced by them can be used as an alternative way of powering the various pumps and any other electrical apparatus used in or to enhance the distillation process, especially during times when there is sunlight but no wind. Adding this, of course, adds cost, and it is a social, marketing and engineering exercise to determine when such an addition is appropriate. The solar cells would normally be placed on the sides of the turbine so as not to interfere with the sunlight being used for distillation. Solar cells work reasonably well with such solar light which would generally be more indirect that the solar light used for distillation. One can even imagine using the solar cell generated electricity to add to the electricity generated by the wind turbine and used for commercial and residential use. However, solar cells generate dc voltage, so this would need to be appropriately converted to the correct ac voltage, and the cost of doing so may make such an approach economically unattractive.

Advantages

From the description above, a number of advantages of this method of using a wind turbine that generates electricity to also obtain potable water from unpurified water are apparent:
(a) A water distillation system is added to the wind turbine system without any significant additional use of real estate.
(b) The cost of the distillation system is partly offset by simply using a different material for the roof of the turbine system.
(c) Energy to pump the purified water elsewhere for storage is directly obtained from the wind turbine.
(d) Energy to maintain the cleanliness of the parts of the system used to transport unpurified water is directly obtained from the wind turbine, and the water used for this operation is also readily available from either the unpurified or potable water.
(e) Energy to maintain the translucent or transparent properties of the roof needed for good distillation is directly obtained from the wind turbine, and the water used for this operation is also readily available from either the unpurified or potable water.
(f) If the turbine is generating more electricity than is needed elsewhere, the residual energy can be used to aid the distillation process, in effect storing excess electrical energy as potable water.
(g) Bacteria present in the unpurified water is killed by the ultra-violate radiation, significantly reducing cross pollution from the impure water to the purified water.
(h) Residual energy can also be used for an electrolysis process to produce chlorine to add to the pure water to protect against future bacteria growth.
(i) The sides of the wind turbine can be used for solar cells which can aid in the distillation process, especially when there is no wind.

### CONCULSIONS, RAMIFICATIONS, AND SCOPE

Accordingly, it is evident that this invention discloses a means for using a wind turbine that is used for generating electricity to also produce purified drinking water and to help maintain the pure water generation part of the system.

1. A means of generating purified drinking water is composed of a conventional wind turbine such as is commonly used to generate electricity is located in or near a large source of water that is not suitable for drinking such as sea water or polluted lake, said turbine being modified such that:
a portion of the energy developed by the rotating blades is used to pump water to the top of said turbine;
roof of said turbine is translucent or transparent to sunlight;
said unsuitable for drinking water is allowed to flow into a conventional water distillation system under said roof;
said sunlight causes said unsuitable for drinking water to evaporate leaving the all the various pollutants behind;
said evaporated water condenses on the underside of said translucent or transparent roof;
said condensed water being free of pollutants is suitable for drinking water;
said underside of said translucent or transparent roof is designed according to conventional sea water distillation means whereby said suitable for drinking water can be drained and collected.

2. A means of collecting pure water suitable for drinking as described in claim 1 whereby the collected water may be drained by gravity feed for storage elsewhere.

3. A means of collecting pure water suitable for drinking as described in claim 1 whereby the collected water may be pumped using energy from said turbines to storage elsewhere.

4. A means of collecting pure water suitable for drinking as described in claim 1 whereby the various pollutants collected in said channels used for initially collecting said unsuitable for drinking water are flushed away by temporarily halting the distillation process and allowing said channels used for initially collecting said unsuitable for drinking water to drain wherein additional water used to flush the system may be either the unsuitable for drinking water or the suitable for drinking water; energy for said flushing may be obtained as needed from said turbines.

5. A means of collecting pure water suitable for drinking as described in claim 1 whereby a portion of the stored purified for drinking water is used to clean the outside of said roof therein maintaining its translucent or transparent quality; energy for said cleaning may be obtained as needed from said turbines.

6. A means of collecting pure water suitable for drinking as described in claim 1 whereby said unsuitable for drinking water is used to clean the outside of said roof therein maintaining its translucent or transparent quality; energy for said cleaning may be obtained as needed from said turbines.

7. A means of collecting pure water suitable for drinking as described in claim 1 whereby said distillation process can be aided by using electricity being generated by said turbines but not required for other uses and applying said electricity via any appropriate conventional means to said distillation process.

8. A means of storing excess generating capacity obtained as described in claim 1 in the form of potable drinking water.

9. A means of using excess generating capacity obtained as described in claim 1 to drive electrolysis of sea water whereby the chlorine produced can be used to protect against future bacterial growth.

10. A means as described in claim 1 wherein solar cells are added whereby the distillation process can be aided by electrical energy generated by those solar cells.
